(19) United States
(12) Patent Application Publication
(10) Pub. No.: US 2025/0052190 A1
(43) Pub. Date: Feb. 13, 2025

(54) TURBINE ENGINE INCLUDING A STEAM SYSTEM

(71) Applicant: General Electric Company, Schenectady, NY (US)

(72) Inventor: Arthur W. Sibbach, Boxford, MA (US)

(21) Appl. No.: 18/448,597

(22) Filed: Aug. 11, 2023

(51) Int. Cl. F02C 3/30; F02C 3/06

(52) U.S. Cl. CPC F02C 3/30; F05D 2220/323; F05D 2270/07; F05D 2270/08

(57) ABSTRACT

A turbine engine for an aircraft. The turbine engine includes a combustor, a turbine, a boiler, a steam turbine, and a reheat boiler. The combustor generates combustion gases and the turbine is positioned downstream of the combustor to receive the combustion gases and to rotate the turbine. The boiler is positioned downstream of the combustor to receive the combustion gases and to boil water to generate steam. The steam turbine is fluidly coupled to the boiler to receive the steam from the boiler and to rotate the steam turbine. Each of the turbine and the steam turbine is drivingly coupled to a core shaft to rotate the core shaft. The reheat boiler is fluidly coupled to the steam turbine to receive the steam from the steam turbine and to reheat the steam. The combustor is fluidly coupled to the reheat boiler to receive the reheated steam.

### TECHNICAL FIELD

The present disclosure relates generally to turbine engines including a steam system.

### BACKGROUND

Turbine engines used in aircraft generally include a fan and a core section arranged in flow communication with one another. A combustor is arranged in the core section to generate combustion gases for driving a turbine in the core section of the turbine engine.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 is a schematic cross-sectional diagram of a turbine engine including a steam system, taken along a longitudinal centerline axis of the turbine engine, according to the present disclosure.

FIG. 2 is a schematic diagram of the turbine engine and the steam system of FIG. 1, according to the present disclosure.

### DETAILED DESCRIPTION

Features, advantages, and embodiments of the present disclosure are set forth or apparent from a consideration of the following detailed description, drawings, and claims. Moreover, the following detailed description is exemplary and intended to provide explanation without limiting the scope of the disclosure as claimed.

Various embodiments of the present disclosure are discussed in detail below. While specific embodiments are discussed, this is done for illustration purposes only. A person skilled in the relevant art will recognize that other components and configurations may be used without departing from the spirit and the scope of the present disclosure.

As used herein, the terms “first,” “second,” “third,” and “fourth” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or a vehicle, and refer to the normal operational attitude of the turbine engine or the vehicle. For example, with regard to a turbine engine, forward refers to a position closer to an engine inlet and aft refers to a position closer to an engine nozzle or an exhaust.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, a “bypass ratio” of a turbine engine is a ratio of bypass air through a bypass of the turbine engine to core air through a core inlet of a core turbine engine of the turbine engine. For example, the bypass ratio is a ratio of bypass air 62 entering the bypass airflow passage 56 to core air 64 entering the core turbine engine 16.

As used herein, a “compression ratio” of a compressor is a ratio of a compressor exit pressure at an exit of the compressor to a compressor inlet pressure at an inlet of the compressor. The compressor exit pressure and the compressor inlet pressure are measured as static air pressures perpendicular to the direction of the core air flow through the compressor.

As used herein, a “pressure expansion ratio” of a turbine is a ratio of a pressure at an inlet of the turbine to a pressure at an exit of the turbine.

Here and throughout the specification and claims, range limitations are combined, and interchanged. Such ranges are identified and include all the sub-ranges contained therein unless context or language indicates otherwise. For example, all ranges disclosed herein are inclusive of the endpoints, and the endpoints are independently combinable with each other.

As noted above, a combustor is arranged in the core section to generate combustion gases for driving a turbine in the core section of the turbine engine. Not all of the energy and heat generated by the combustor is used to drive the turbine(s) of the turbine section. Instead, some of the waste heat is exhausted through a jet exhaust nozzle section in a conventional turbine engine. The turbine engine discussed herein includes a steam system that is used to recover some of the energy from the waste heat by generating steam and driving a steam turbine. After flowing through the steam turbine, the steam may be injected into the combustor. Injecting cooled steam into the combustor reduces the efficiency of the combustor and, in the embodiments discussed herein, the steam is reheated prior to being injected into the combustor. Not only does this increase the efficiency of the combustor, but the steam turbine can be made larger, further increasing the efficiency of the system overall.

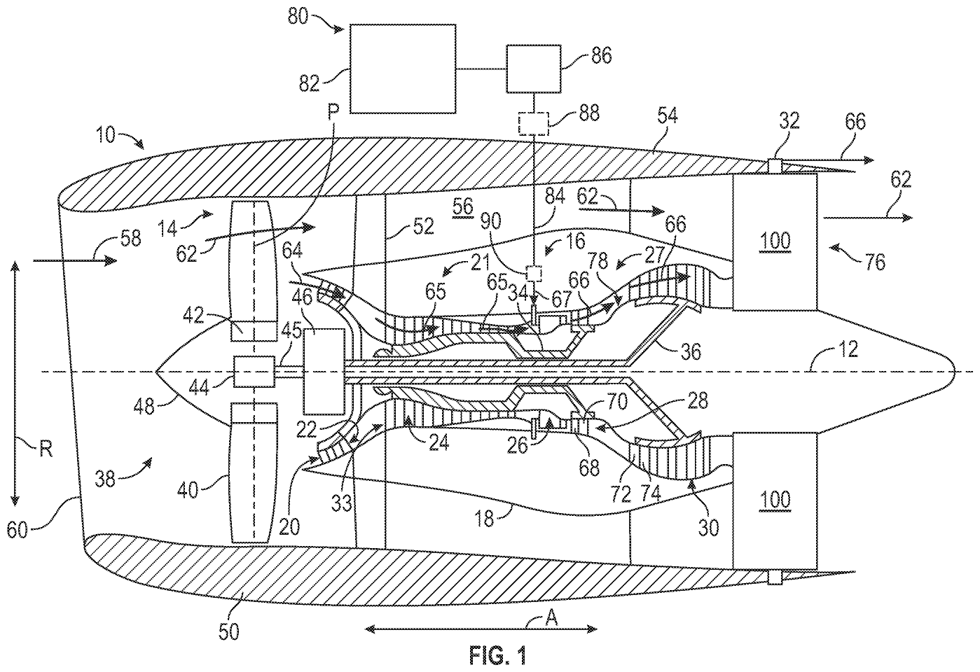

Referring now to the drawings, FIG. 1 is a schematic cross-sectional diagram of a turbine engine 10 including a steam system 100, taken along a longitudinal centerline axis 12 (provided for reference) of the turbine engine 10, according to an embodiment of the present disclosure. As shown in FIG. 1, the turbine engine 10 has an axial direction A (extending parallel to the longitudinal centerline axis 12) and a radial direction R that is normal to the axial direction A. In general, the turbine engine 10 includes a fan section 14 and a core turbine engine 16 disposed downstream from the fan section 14.

The core turbine engine 16 includes an outer casing 18 that is substantially tubular and defines an annular core inlet 20. As schematically shown in FIG. 1, the outer casing 18 encases, in serial flow relationship, a compressor section 21 including a booster or a low-pressure compressor (LPC) 22 followed downstream by a high-pressure compressor (HPC) 24, a combustor 26, a turbine section 27, including a high-pressure turbine (HPT) 28, followed downstream by a low-pressure turbine (LPT) 30, and one or more core exhaust nozzles 32. A high-pressure (HP) shaft 34 or a spool drivingly connects the HPT 28 to the HPC 24 to rotate the HPT 28 and the HPC 24 in unison. The HPT 28 is drivingly coupled to the HP shaft 34 to rotate the HP shaft 34 when the HPT 28 rotates. A low-pressure (LP) shaft 36 drivingly connects the LPT 30 to the LPC 22 to rotate the LPT 30 and the LPC 22 in unison. The LPT 30 is drivingly coupled to the LP shaft 36 to rotate the LP shaft 36 when the LPT 30 rotates. The compressor section 21, the combustor 26, the turbine section 27, and the one or more core exhaust nozzles 32 together define a core air flow path 33.

For the embodiment depicted in FIG. 1, the fan section 14 includes a fan 38 (e.g., a variable pitch fan) having a plurality of fan blades 40 coupled to a disk 42 in a spaced apart manner. As depicted in FIG. 1, the fan blades 40 extend outwardly from the disk 42 generally along the radial direction R. Each fan blade 40 is rotatable relative to the disk 42 about a pitch axis P by virtue of the fan blades 40 being operatively coupled to an actuator 44 configured to collectively vary the pitch of the fan blades 40 in unison. The fan blades 40, the disk 42, and the actuator 44 are together rotatable about the longitudinal centerline axis 12 via a fan shaft 45 that is powered by the LP shaft 36 across a power gearbox, also referred to as a gearbox assembly 46. The gearbox assembly 46 is shown schematically in FIG. 1. The gearbox assembly 46 includes a plurality of gears for adjusting the rotational speed of the fan shaft 45 and, thus, the fan 38 relative to the LP shaft 36.

Referring still to the exemplary embodiment of FIG. 1, the disk 42 is covered by a rotatable fan hub 48 aerodynamically contoured to promote an airflow through the plurality of fan blades 40. In addition, the fan section 14 includes an annular fan casing or a nacelle 50 that circumferentially surrounds the fan 38 and/or at least a portion of the core turbine engine 16. The nacelle 50 is supported relative to the core turbine engine 16 by a plurality of circumferentially spaced outlet guide vanes 52. Moreover, a downstream section 54 of the nacelle 50 extends over an outer portion of the core turbine engine 16 to define a bypass airflow passage 56 therebetween. The one or more core exhaust nozzles 32 may extend through the nacelle 50 and be formed therein. In this embodiment, the one or more core exhaust nozzles 32 include one or more discrete nozzles that are spaced circumferentially about the nacelle 50. Other arrangements of the core exhaust nozzles 32 may be used including, for example, a single core exhaust nozzle that is annular, or partially annular, about the nacelle 50.

During operation of the turbine engine 10, a volume of air 58 enters the turbine engine 10 through an inlet 60 of the nacelle 50 and/or the fan section 14. As the volume of air 58 passes across the fan blades 40, a first portion of air (bypass air 62) is directed or routed into the bypass airflow passage 56, and a second portion of air (core air 64) is directed or is routed into the upstream section of the core air flow path 33, or, more specifically, into the core inlet 20. The ratio between the first portion of air (bypass air 62) and the second portion of air (core air 64) is known as a bypass ratio. In some embodiments, the bypass ratio is greater than 18:1, enabled by a steam system 100, detailed further below. The pressure of the core air 64 is then increased by the LPC 22, forming compressed air 65, and the compressed air 65 is routed through the HPC 24 and further compressed before being directed into the combustor 26, where the compressed air 65 is mixed with fuel 67 and burned to generate combustion gases 66 (combustion products). One or more stages may be used in each of the LPC 22 and the HPC 24, with each subsequent stage further compressing the compressed air 65. The HPC 24 has a compression ratio greater than 20:1, preferably, in a range of 20:1 to 40:1. The compression ratio is a ratio of a pressure of a last stage of the HPC 24 to a pressure of a first stage of the HPC 24. The compression ratio greater than 20:1 is enabled by the steam system 100, as detailed further below.

The combustion gases 66 are routed into the HPT 28 and expanded through the HPT 28 where a portion of thermal energy and/or kinetic energy from the combustion gases 66 is extracted via sequential stages of HPT stator vanes 68 that are coupled to the outer casing 18 and HPT rotor blades 70 that are coupled to the HP shaft 34, thus, causing the HP shaft 34 to rotate, thereby supporting operation of the HPC 24. The combustion gases 66 are then routed into the LPT 30 and expanded through the LPT 30. Here, a second portion of thermal energy and/or the kinetic energy is extracted from the combustion gases 66 via sequential stages of LPT stator vanes 72 that are coupled to the outer casing 18 and LPT rotor blades 74 that are coupled to the LP shaft 36, thus, causing the LP shaft 36 to rotate, thereby supporting operation of the LPC 22 and rotation of the fan 38 via the gearbox assembly 46. One or more stages may be used in each of the HPT 28 and the LPT 30. The HPC 24 having a compression ratio in a range of 20:1 to 40:1 results in the HPT 28 having a pressure expansion ratio in a range of 1.5:1 to 4:1 and the LPT 30 having a pressure expansion ratio in a range of 4.5:1 to 28:1.

The combustion gases 66, after being routed through the steam system 100 (as discussed below), are subsequently routed through the one or more core exhaust nozzles 32 of the core turbine engine 16 to provide propulsive thrust. Simultaneously with the flow of the core air 64 through the core air flow path 33, the bypass air 62 is routed through the bypass airflow passage 56 before being exhausted from a fan bypass nozzle 76 of the turbine engine 10, also providing propulsive thrust. The HPT 28, the LPT 30, and the one or more core exhaust nozzles 32 at least partially define a hot gas path 78 for routing the combustion gases 66 through the core turbine engine 16.

As noted above, the compressed air 65 (the core air 64) is mixed with the fuel 67 in the combustor 26 to form a fuel and air mixture, and combusted, generating combustion gases 66 (combustion products). The fuel 67 can include any type of fuel used for turbine engines, such as, for example, sustainable aviation fuels (SAF) including biofuels, JetA, or other hydrocarbon fuels. The fuel 67 also may be a hydrogen-based fuel (H₂), and, while hydrogen-based fuel may include blends with hydrocarbon fuels, the fuel 67 used herein is preferably unblended, and referred to herein as hydrogen fuel. In some embodiments, the hydrogen fuel may comprise substantially pure hydrogen molecules (i.e., diatomic hydrogen). The fuel 67 may also be a cryogenic fuel. For example, when the hydrogen fuel is used, the hydrogen fuel may be stored in a liquid phase at cryogenic temperatures.

The turbine engine 10 includes a fuel system 80 for providing the fuel 67 to the combustor 26. The fuel system 80 includes a fuel tank 82 for storing the fuel 67 therein, and a fuel delivery assembly 84. The fuel tank 82 can be located on an aircraft (not shown) to which the turbine engine 10 is attached. While a single fuel tank 82 is shown in FIG. 1, the fuel system 80 can include any number of fuel tanks 82, as desired. The fuel delivery assembly 84 delivers the fuel 67 from the fuel tank 82 to the combustor 26. The fuel delivery assembly 84 includes one or more lines, conduits, pipes, tubes, etc., configured to carry the fuel 67 from the fuel tank 82 to the combustor 26. The fuel delivery assembly 84 also includes a pump 86 to induce the flow of the fuel 67 through the fuel delivery assembly 84 to the combustor 26. In this way, the pump 86 pumps the fuel 67 from the fuel tank 82, through the fuel delivery assembly 84, and into the combustor 26. The fuel system 80 and, more specifically, the fuel tank 82 and the fuel delivery assembly 84, either collectively or individually, may be a fuel source for the combustor 26.

In some embodiments, for example, when the fuel 67 is a hydrogen fuel, the fuel system 80 includes one or more vaporizers 88 (illustrated by dashed lines) and a metering valve 90 (illustrated by dashed lines) in fluid communication with the fuel delivery assembly 84. In this example, the hydrogen fuel is stored in the fuel tank 82 as liquid hydrogen fuel. The one or more vaporizers 88 heat the liquid hydrogen fuel flowing through the fuel delivery assembly 84. The one or more vaporizers 88 are positioned in the flow path of the fuel 67 between the fuel tank 82 and the combustor 26, and are located downstream of the pump 86. The one or more vaporizers 88 are in thermal communication with at least one heat source, such as, for example, waste heat from the turbine engine 10 and/or from one or more systems of the aircraft (not shown). The one or more vaporizers 88 heat the liquid hydrogen fuel and the liquid hydrogen fuel is converted into a gaseous hydrogen fuel within the one or more vaporizers 88. The fuel delivery assembly 84 directs the gaseous hydrogen fuel into the combustor 26.

The metering valve 90 is positioned downstream of the one or move vaporizers 88 and the pump 86. The metering valve 90 receives hydrogen fuel in a substantially completely gaseous phase, or in a substantially completely supercritical phase. The metering valve 90 provides the flow of fuel to the combustor 26 in a desired manner. More specifically, the metering valve 90 provides a desired volume of hydrogen fuel at, for example, a desired flow rate, to a fuel manifold that includes one or more fuel injectors that inject the hydrogen fuel into the combustor 26. The fuel system 80 can include any components for supplying the fuel 67 from the fuel tank 82 to the combustor 26, as desired.

The turbine engine 10 includes the steam system 100 in fluid communication with the one or more core exhaust nozzles 32 and the fan bypass nozzle 76. The steam system 100 extracts steam from the combustion gases 66 as the combustion gases 66 flow through the steam system 100, as detailed further below.

The turbine engine 10 depicted in FIG. 1 is by way of example only. In other exemplary embodiments, the turbine engine 10 may have any other suitable configuration. For example, in other exemplary embodiments, the fan 38 may be configured in any other suitable manner (e.g., as a fixed pitch fan) and further may be supported using any other suitable fan frame configuration. Moreover, in other exemplary embodiments, any other suitable number or configuration of compressors, turbines, shafts, or a combination thereof may be provided. In still other exemplary embodiments, aspects of the present disclosure may be incorporated into any other suitable turbine engine, such as, for example, turbofan engines, propfan engines, and/or turboprop engines.

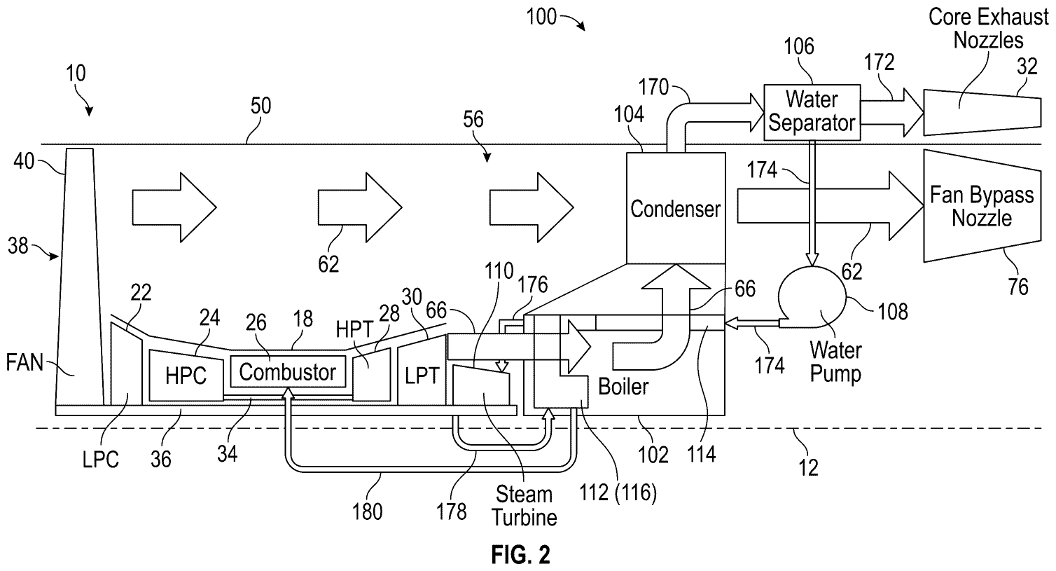

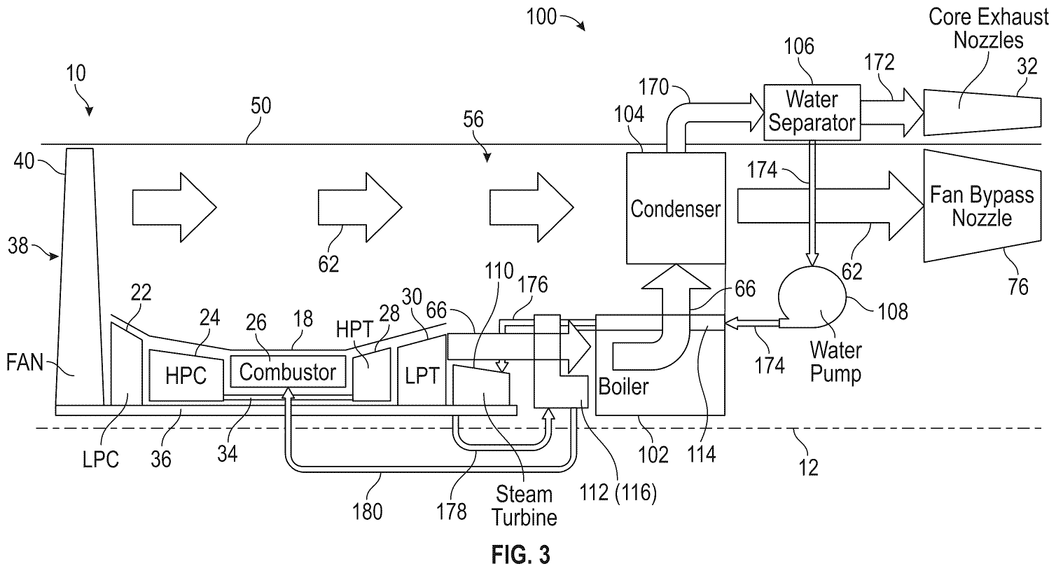

FIG. 2 is a schematic diagram of the turbine engine 10 and the steam system 100 of FIG. 1, according to the present disclosure. For clarity, the turbine engine 10 is shown schematically in FIG. 2 and some components are not shown in FIG. 2. The steam system 100 includes a boiler 102, a condenser 104, a water separator 106, a water pump 108, and a steam turbine 110.

The boiler 102 is a heat exchanger that vaporizes liquid water from a water source to generate steam or water vapor, as detailed further below. The boiler 102 is thus a steam source. In particular, the boiler 102 is an exhaust gas-water heat exchanger. The boiler 102 is in fluid communication with the hot gas path 78 (FIG. 1) and is positioned downstream of the LPT 30. The boiler 102 is also in fluid communication with the water pump 108, as detailed further below. The boiler 102 can include any type of boiler or heat exchanger for extracting heat from the combustion gases 66 and vaporizing liquid water into steam or water vapor as the liquid water and the combustion gases 66 flow through the boiler 102.

The condenser 104 is a heat exchanger that further cools the combustion gases 66 as the combustion gases 66 flow through the condenser 104, as detailed further below. In particular, the condenser 104 is an air-exhaust gas heat exchanger. The condenser 104 is in fluid communication with the boiler 102 and is positioned within the bypass airflow passage 56. The condenser 104 can include any type of condenser for condensing water (e.g., in liquid form) from the exhaust (e.g., the combustion gases 66).

The water separator 106 is in fluid communication with the condenser 104 for receiving cooled exhaust (combustion gases 66) having condensed water entrained therein. The water separator 106 is also in fluid communication with the one or more core exhaust nozzles 32 and with the water pump 108. The water separator 106 includes any type of water separator for separating water from the exhaust. For example, the water separator 106 can include a cyclonic separator that uses vortex separation to separate the water from the air. In such embodiments, the water separator 106 generates a cyclonic flow within the water separator 106 to separate the water from the cooled exhaust. In FIG. 2, the water separator 106 is schematically depicted as being in the nacelle 50, but the water separator 106 could be located at other locations within the turbine engine 10, such as, for example, radially inward of the nacelle 50, closer to the core turbine engine 16. The water separator 106 may be driven to rotate by one of the core shafts, such as the HP shaft 34 or the LP shaft 36. As noted above, the boiler 102 receives liquid water from a water source to generate steam or water vapor. In the embodiment depicted in FIG. 2, the condenser 104 and the water separator 106, individually or collectively, are the water source for the boiler 102.

The water pump 108 is in fluid communication with the water separator 106 and with the boiler 102. The water pump 108 is in fluid communication with the condenser 104 via the water separator 106. The water pump 108 may be any suitable pump, such as a centrifugal pump or a positive displacement pump. The water pump 108 directs the separated liquid water through the boiler 102 where it is converted back to steam. This steam is sent through the steam turbine 110 then injected into core air flow path 33, such as into the combustor 26.

In operation, the combustion gases 66, also referred to as exhaust, flow from the LPT 30 into the boiler 102. The combustion gases 66 transfer heat into the water 174 (e.g., in liquid form) within the boiler 102, as detailed further below. The combustion gases 66 then flow into the condenser 104. The condenser 104 condenses the water 174 (e.g., in liquid form) from the combustion gases 66. The bypass air 62 flows through the bypass airflow passage 56 and over or through the condenser 104 and extracts heat from the combustion gases 66, cooling the combustion gases 66 and condensing the water 174 from the combustion gases 66, to generate an exhaust-water mixture 170. The bypass air 62 is then exhausted out of the turbine engine 10 through the fan bypass nozzle 76 to generate thrust, as detailed above. The condenser 104 thus may be positioned in bypass airflow passage 56.

The exhaust-water mixture 170 flows into the water separator 106. The water separator 106 separates the water 174 from the exhaust of the exhaust-water mixture 170 to generate separate exhaust 172 and the water 174. The exhaust 172 is exhausted out of the turbine engine 10 through the one or more core exhaust nozzles 32 to generate thrust, as detailed above. The boiler 102, the condenser 104, and the water separator 106 thus also define a portion of the hot gas path 78 (see FIG. 1) for routing the combustion gases 66, the exhaust-water mixture 170, and the exhaust 172 through the steam system 100 of the turbine engine 10.

The water pump 108 pumps the water 174 (e.g., in liquid form) through one or more water lines (as indicated by the arrow for the water 174 in FIG. 2) and the water 174 flows through the boiler 102. As the water 174 flows through the boiler 102, the combustion gases 66 flowing through the boiler 102 transfer heat into the water 174 to vaporize the water 174 and to generate the steam 176 (e.g., vapor). The steam turbine 110 includes one or more stages of steam turbine blades (not shown) and steam turbine stators (not shown). The steam 176 flows from the boiler 102 into the steam turbine 110, through one or more steam lines (as indicated by the arrow for the steam 176 in FIG. 2), causing the steam turbine blades of the steam turbine 110 to rotate, thereby generating additional work in an output shaft (e.g., one of the core shafts) connected to the turbine blades of the steam turbine 110.

As noted above, the core turbine engine 16 includes shafts, also referred to as core shafts, coupling various rotating components of the core turbine engine 16 and other thrust producing components such as the fan 38. In the core turbine engine 16 shown in FIG. 1, these core shafts include the HP shaft 34 and the LP shaft 36. The steam turbine 110 is coupled to one of the core shafts of the core turbine engine 16, such as the HP shaft 34 or the LP shaft 36. In the illustrated embodiment, the steam turbine 110 is coupled to the LP shaft 36. As the steam 176 flows from the boiler 102 through the steam turbine 110, the kinetic energy of this gas is converted by the steam turbine 110 into mechanical work in the LP shaft 36. The reduced temperature steam (as steam 178) exiting the steam turbine 110 is then injected into the core air flow path 33, such as into the combustor 26, upstream of the combustor 26, or downstream of the combustor 26. The steam 178 flows through one or more steam lines from the steam turbine 110 to the core air flow path 33. The steam 178 injected into the core air flow path 33 adds mass flow to the core air 64 such that less core air 64 is needed to produce the same amount of work through the turbine section 27. In this way, the steam system 100 extracts additional work from the heat in exhaust gas that would otherwise be wasted. The steam 178 injected into the core air flow path 33 is in a range of 20% to 50% of the mass flow through the core air flow path 33.

The steam turbine 110 may have a pressure expansion ratio in a range of 2:1 to 6:1. The pressure expansion ratio is a ratio of the pressure at an inlet of the steam turbine 110 to the pressure at an exit of the steam turbine 110. The steam turbine 110 may contribute approximately 25% of the power to the LP shaft 36 (or to the HP shaft 34) when the steam system 100 recovers approximately 70% of the water 174 and converts the water 174 into the steam 176. The steam turbine 110 has a pressure expansion ratio in a range of 2:1 to 6:1, the LPT 30 has a pressure expansion ratio in a range of 4.5:1 to 28:1, and the steam 178 contributes to 20% to 50% of the mass flow through the core air flow path 33. The steam turbine 110 expands the steam 176, thereby reducing the energy of the steam 178 exiting the steam turbine 110 and reducing the temperature of the steam 178 to approximately a temperature of the compressed air 65 (see FIG. 1) that is discharged from the HPC 24. Such a configuration enables the steam 178 to reduce hot spots in the combustor 26 from the combustion of the fuel (e.g., in particular when the fuel is supercritical hydrogen or gaseous hydrogen).

The steam 178 injected into the core air flow path 33 also enables the HPT 28 to have a greater energy output with fewer stages of the HPT 28 as compared to HPTs without the benefit of the present disclosure. For example, the additional mass flow from the steam 178 through the turbine section 27 helps to produce a greater energy output. In this way, HPT 28 may only have one stage capable sustainably driving a higher number of stages of the HPC 24 (e.g., 10, 11, or 12 stages of the HPC 24) due to the higher mass flow (resulting from the steam injection) exiting the combustor 26. The steam 178 that is injected into the core air flow path 33 enables the HPT 28 to have only one stage that drives the plurality of stages of the HPC 24 without reducing an amount of work that the HPT 28 produces as compared to HPTs without the benefit of the present disclosure, while also reducing a weight of the HPT 28 and increasing an efficiency of the HPT 28, as compared to HPTs without the benefit of the present disclosure.

With less core air 64 (see FIG. 1) needed due to the added mass flow from the steam 176, the compression ratio of the HPC 24 may be increased as compared to HPCs without the benefit of the present disclosure. In this way, the HPC 24 has a compression ratio greater than 20:1. In some embodiments, the compression ratio of the HPC 24 is in a range of 20:1 to 40:1. Thus, the compression ratio of the HPC 24 is increased, thereby increasing the thermal efficiency of the turbine engine 10 as compared to HPCs and turbine engines without the benefit of the present disclosure. Further, the HPC 24 may have a reduced throat area due to the added mass flow in the core turbine engine 16 provided by the steam 176, 178 injected into the core turbine engine 16. Accordingly, the HPC 24 has a reduced size (e.g., outer diameter) and a reduced weight, as compared to turbine engines without the benefit of the present disclosure.

In some embodiments, the HPC stator vanes of at least two stages of the HPC 24 are variable stator vanes that are controlled to be pitched about a pitch axis to vary a pitch of the HPC stator vanes. In some embodiments, the HPC 24 includes one or more compressor bleed valves that are controlled to be opened to bleed a portion of the compressed air 65 (see FIG. 1) from the HPC 24. The one or more compressor bleed valves are preferably positioned between a fourth stage of the HPC 24 and a last stage of the HPC 24. The HPC stator vanes that are variable stator vanes, and the one or more compressor bleed valves help to balance the air flow (e.g., the compressed air 65) through all stages of the HPC 24. Such a balance, in combination with the steam 178 injected into the core air flow path 33, enables the number of stages of the HPC 24 to include ten to twelve stages for compression ratios to be greater than 20:1, and preferably in a range of 20:1 to 40:1.

The additional work that is extracted by the steam system 100 and the steam 178 injected into the core air flow path 33 enables a size of the core turbine engine 16 (FIG. 1) to be reduced, thereby increasing the bypass ratio of the turbine engine 10, as compared to turbine engines without the benefit of the present disclosure. In this way, the turbine engine 10 has a bypass ratio greater than 18:1, preferably, in a range of 18:1 to 100:1, more preferably, in a range of 25:1 to 85:1, and, most preferably, in a range of 28:1 to 70:1. In this way, the steam system 100 can enable an increased bypass ratio in which the turbine engine 10 can move a larger mass of air through the bypass, reducing the pressure ratio of the fan 38 and increasing the efficiency of the turbine engine 10 as compared to turbine engines without the benefit of the present disclosure.

As noted above, work is extracted from the steam 176 in the steam turbine 110. Extracting this work reduces the temperature and the pressure of the steam 178 downstream of the steam turbine 110. The temperature of the steam being input into the combustor 26, however, preferably is at a relatively high temperature (as will be discussed further below), as higher temperatures result in higher energy and thus thrust. Instead of the steam 178 flowing directly from the steam turbine 110 into the combustor 26, the steam 178 is reheated before being injected into the combustor 26. In this embodiment, the steam 178 is reheated by a reheat boiler 112 to form reheated steam 180. The reheat boiler 112 is fluidly connected to the steam turbine 110 by one or more steam lines (as indicated by the arrow for the steam 178 in FIG. 2). The reheat boiler 112 is positioned downstream of the steam turbine 110 with respect to the flow path of the steam 178. The reheat boiler 112 is also fluidly connected to the combustor 26 by one or more steam lines (as indicated by the arrow for the reheated steam 180 in FIG. 2). The reheat boiler 112 is positioned upstream of the combustor 26 relative to the flow path of the reheated steam 180.

Although the reheat boiler 112 may be a separate boiler from the boiler 102, the reheat boiler 112 is integrated into the boiler 102 in this embodiment. The boiler 102 of this embodiment thus includes a plurality of flow paths for the steam, including an initial steam flow path 114 and a reheat steam flow path 116. The water 174 flows through the initial steam flow path 114 to generate the steam 176 that subsequently flows into the steam turbine 110. The steam 178, after flowing through the steam turbine 110, then flows through the reheat steam flow path 116 where the steam 176 absorbs heat from the combustion gases 66 increasing the temperature of the steam 176 and generating the reheated steam 180.

As higher temperatures of the reheated steam 180 are desired, the reheat steam flow path 116 is preferably located upstream of the initial steam flow path 114 relative to the flow of combustion gases 66 from the LPT 30. The reheat steam flow path 116 may thus be located upstream of the initial steam flow path 114 relative to the flow of combustion gases 66, or when the reheat boiler 112 is a separate boiler the reheat boiler 112 is located upstream of the boiler 102 relative to the flow of combustion gases 66. In this way, the steam 178 being reheated is exposed to the highest temperatures of the combustion gases 66, allowing the reheated steam 180 to reach the desired temperatures. A further advantage of reheating the steam 176 from the steam turbine 110 before being injected into the combustor 26 is that the sizing of the steam turbine 110 does not have to be limited by considerations of the temperature of the steam 178 being injected into the combustor 26 and the impact of those temperatures on combustion. Instead, the size and stages of the steam turbine 110 can be increased to extract additional work out of the steam 176 (steam 178).

When work is extracted from the steam 176 (steam 178) in the steam turbine 110 as discussed above, water may condense and be entrained in the steam. Water droplets remaining in the steam being injected into the combustor 26 not only reduce efficiency, as heat is expended to evaporate the water, but also the high-velocity water droplets may damage components of the core turbine engine 16, such as the HPT rotor blades 70 and the LPT rotor blades 74, for example. Accordingly, the reheated steam 180 is preferably steam without water droplets and may be superheated steam. The combustor 26 has a combustion pressure (pressure within the combustion chamber of the combustor 26). The temperature of the reheated steam 180 exiting the reheat steam flow path 116 and being injected into the combustor 26 is preferably at least the boiling point of water at the combustion pressure.

The combustion gases 66 have a temperature exiting the LPT 30, referred to herein as the LPT exit temperature. As noted above, the combustion gases 66 are used to reheat the steam 178, and thus the temperature of the reheated steam 180 exiting the reheat steam flow path 116 is less than the LPT exit temperature, such as, for example, at least one hundred degrees Fahrenheit (100° F.) less than the LPT exit temperature (at least thirty-eight degrees Celsius (38° C.) less than the LPT exit temperature). As the steam system 100 is designed for use on an aircraft, weight and size considerations should be taken into account when sizing the boiler 102 and, thus, when such considerations are taken into account, the temperature of the reheated steam 180 exiting the reheat steam flow path 116 is less than the LPT exit temperature, such as, for example, at least two hundred degrees Fahrenheit (200° F.) less than the LPT exit temperature (at least thirty-eight degrees Celsius (93° C.) less than the LPT exit temperature).

The temperature of the reheated steam 180 at the exit of the boiler 102 (more specifically, the exit of the reheat steam flow path 116) and/or when injected into the combustor 26 may thus be from T₁ to T₂. T₁ is at least the boiling point of water at the combustion pressure. T₂ may be a temperature less than the LPT exit temperature. T₂ preferably may be one hundred degrees Fahrenheit (100° F.) less than the LPT exit temperature (at least thirty-eight degrees Celsius (38° C.) less than the LPT exit temperature) and more preferably may be two hundred degrees Fahrenheit (200° F.) less than the LPT exit temperature (at least thirty-eight degrees Celsius (93° C.) less than the LPT exit temperature).

Reheating the steam 178 after flowing through the steam turbine 110 and prior to being injected into the combustor 26 (reheated steam 180) can increase the efficiency of the turbine engine 10 by increasing the temperature (and thus efficiency) of the steam flowing into the combustor 26. Reheating the steam 178 also allows an increase in the size of the steam turbine 110, thus, allowing for additional work to be extracted from the steam 176. In addition, such a configuration can prevent water droplets from being entrained in the steam injected into the combustor 26, and, thus, prevent the damage therefrom.

Further aspects of the present disclosure are provided by the subject matter of the following clauses.

A turbine engine for an aircraft. The turbine engine includes a core turbine engine, a fan having a fan shaft coupled to the core turbine engine to rotate the fan shaft, and a steam system. The core turbine engine includes a core air flow path for core air to flow therethrough, a combustor, a core shaft, and a turbine. The combustor is positioned in the core air flow path to receive compressed air and fluidly coupled to a fuel to receive fuel. The fuel is injected into the combustor to mix with the compressed air to generate a fuel and air mixture, and the fuel and air mixture is combusted in the combustor to generate combustion gases. The turbine located downstream of the combustor to receive the combustion gases and to cause the turbine to rotate. The turbine is coupled to the core shaft to rotate the core shaft when the turbine rotates. The steam system is fluidly coupled to the combustor to provide reheated steam to the core air flow path to add mass flow to the core air. The steam system includes a boiler, a steam turbine, and a reheat boiler. The boiler is positioned downstream of the combustor. The boiler receives water and is fluidly connected to the combustor to receive the combustion gases and to boil the water to generate steam. The steam turbine is turbine fluidly coupled to the boiler to receive the steam from the boiler and to cause the steam turbine to rotate. The steam turbine is coupled to the core shaft to rotate the core shaft when the steam turbine rotates. The reheat boiler is fluidly coupled to the steam turbine to receive the steam from the steam turbine and to reheat the steam. The combustor is fluidly coupled to the reheat boiler to receive the reheated steam.

The turbine engine of the preceding clause, wherein the combustor has a combustion pressure, the reheated steam being reheated by the reheat boiler to have a temperature greater than the boiling point of water at the combustion pressure.

The turbine engine of any preceding clause, wherein the reheat boiler is located upstream of the boiler relative to the flow of combustion gases.

The turbine engine of any preceding clause, wherein the reheat boiler is integrated into the boiler, the boiler having an initial steam flow path and a reheat steam flow path, the steam turbine being fluidly coupled to the initial steam flow path to receive the steam from the boiler, and the combustor being fluidly coupled to the reheat steam flow path to receive the reheated steam.

The turbine engine of any preceding clause, wherein the reheat steam flow path is located upstream of the initial steam flow path relative to the flow of combustion gases.

The turbine engine of any preceding clause, further comprising a bypass airflow passage and a condenser. A first portion of air flowing into the fan flowing through the bypass airflow passage as bypass air and a second portion of the air flowing into the fan flowing through the core air flow path as core air.

The turbine engine of any preceding clause, wherein the condenser is positioned downstream of the boiler and in the bypass airflow passage for bypass air to cool the combustion gases and to condense the water from the combustion gases.

The turbine engine of any preceding clause, wherein the core shaft is a low-pressure shaft and the turbine is a low-pressure turbine.

The turbine engine of any preceding clause, wherein the combustion gases have a low-pressure turbine exit temperature, the reheated steam being reheated by the reheat boiler to have a temperature less than the low-pressure turbine exit temperature.

The turbine engine of any preceding clause, wherein the reheated steam is reheated by the reheat boiler to have a temperature from T1 to T2, wherein the combustor has a combustion pressure, T1 being the boiling point of water at the combustion pressure, and wherein the combustion gases have a low-pressure turbine exit temperature, T₂ being 100° F. (38° C.) less than the low-pressure turbine exit temperature.

The turbine engine of any preceding clause, wherein the reheated steam is reheated by the reheat boiler to have a temperature from T1 to T2, wherein the combustor has a combustion pressure, T1 being the boiling point of water at the combustion pressure, and wherein the combustion gases have a low-pressure turbine exit temperature, T2 being 200° F. (93° C.) less than the low-pressure turbine exit temperature.

The turbine engine of any preceding clause, further comprising a low-pressure compressor connected to the low-pressure shaft to be driven by the low-pressure turbine and the steam turbine.

The turbine engine of any preceding clause, further comprising a fan including a plurality of blades and a fan shaft, the fan shaft being coupled to the low-pressure shaft to be driven by the low-pressure shaft.

The turbine engine of any preceding clause, further comprising a low-pressure compressor positioned in the core air flow path upstream of the combustor, the low-pressure compressor being driven by the low-pressure shaft to compress the core air flowing through the core air flow path and to generate the compressed air.

The turbine engine of any preceding clause, further comprising a high-pressure turbine and a high-pressure shaft. The high-pressure turbine is positioned downstream of the combustor to receive the combustion gases and to cause the high-pressure turbine to rotate. The high-pressure turbine is drivingly coupled to the high-pressure shaft to rotate the high-pressure shaft when the high-pressure turbine rotates.

The turbine engine of the preceding clause, further comprising a high-pressure compressor. The high-pressure compressor is positioned in the core air flow path upstream of the combustor and downstream of the low-pressure compressor. The high-pressure compressor is driven by the high-pressure shaft to compress the core air flowing through the core air flow path and to generate the compressed air.

The turbine engine of any preceding clause, further comprising a condenser positioned downstream of the boiler to condense water from the combustion gases and to form an exhaust-water mixture.

The turbine engine of any preceding clause, further comprising a bypass airflow passage for bypass air, the condenser being positioned in the bypass airflow passage for bypass air to cool the combustion gases and to condense the water from the combustion gases, forming a cooled exhaust.

The turbine engine of any preceding clause, further comprising a water separator positioned downstream of the condenser, the water separator separating the water from the cooled exhaust.

The turbine engine of any preceding clause, wherein the water separator is a cyclonic separator.

The turbine engine of any preceding clause, wherein the boiler is fluidly coupled to the water separator.

The turbine engine of any preceding clause, further comprising a water pump in fluid communication with the water separator and with the boiler to direct the flow of water from the water separator into the boiler.

The turbine engine of any preceding clause, wherein the steam system extracts water from the combustion gases and vaporizes the water to generate steam using the boiler.

The turbine engine of any preceding clause, wherein the fan shaft is coupled to the core shaft such that rotation of the turbine causes the fan to rotate.

The turbine engine of any preceding clause, further comprising a nacelle, and a steam system. The nacelle circumferentially surrounds the fan.

The turbine engine of the preceding clause, wherein the nacelle defines a bypass airflow passage between the nacelle and the core turbine engine.

The turbine engine of the preceding clause, wherein the fan includes a plurality of fan blades that rotate to generate a volume of air. The volume of air from the fan is split and flows into the bypass airflow passage as bypass air and flows into the core air flow path as the core air.

The turbine engine of the preceding clause, wherein a bypass ratio of the bypass air to the core air is greater than 18:1.

The turbine engine of any preceding clause, wherein the bypass ratio is in a range of 18:1 to 100:1.

The turbine engine of any preceding clause, wherein the bypass ratio is in a range of 25:1 to 85:1.

The turbine engine of any preceding clause, wherein the bypass ratio is in a range of 28:1 to 70:1.

The turbine engine of any preceding clause, wherein the bypass air is routed through the bypass airflow passage before being exhausted from a fan bypass nozzle to provide propulsive thrust.

The turbine engine of any preceding clause, wherein the core turbine engine further includes a compressor that compresses the core air to generate the compressed air. The compressor is drivingly coupled to the core shaft and defines a portion of the core air flow path.

The turbine engine of the preceding clause, wherein the compressor includes a high-pressure compressor and includes a compression ratio greater than 20:1.

The turbine engine of the preceding clause, wherein the plurality of stages of the compressor includes ten to twelve stages.

The turbine engine of any preceding clause, wherein the turbine includes a high-pressure turbine (HPT) and includes only one stage of HPT rotor blades and HPT stator vanes.

The turbine engine of any preceding clause, further comprising a low-pressure turbine.

The turbine engine of the preceding clause, wherein the low-pressure turbine has a low-pressure shaft coupled to the fan.

The turbine engine of any preceding clause, further comprising a low-pressure compressor coupled to the low-pressure shaft to be driven by the low-pressure turbine and the steam turbine.

The turbine engine of any preceding clause, the low-pressure turbine having a pressure expansion ratio in a range of 4.5:1 to 28:1.

The turbine engine of any preceding clause, the high-pressure turbine having a pressure expansion ratio in a range of 1.5:1 to 4:1.

Although the foregoing description is directed to the preferred embodiments of the present disclosure, other variations and modifications will be apparent to those skilled in the art and may be made without departing from the spirit or the scope of the disclosure. Moreover, features described in connection with one embodiment of the present disclosure may be used in conjunction with other embodiments, even if not explicitly stated above.

1. A turbine engine for an aircraft, the turbine engine comprising:
a core turbine engine including:
a core air flow path for core air to flow therethrough;
a combustor positioned in the core air flow path to receive compressed air and fluidly coupled to a fuel source to receive fuel, the fuel being injected into the combustor to mix with the compressed air to generate a fuel and air mixture, the fuel and air mixture being combusted in the combustor to generate combustion gases;
a core shaft; and
a turbine located downstream of the combustor to receive the combustion gases and to cause the turbine to rotate, the turbine coupled to the core shaft to rotate the core shaft when the turbine rotates;
a fan coupled to the core turbine engine to be rotated by the core turbine engine;
a steam system fluidly coupled to the combustor to provide reheated steam to the core air flow path to add mass flow to the core air, the steam system including:
a boiler positioned downstream of the combustor, the boiler receiving water and being fluidly connected to the combustor to receive the combustion gases and to boil the water to generate steam, the boiler including an initial steam flow path to receive the water and generate the steam;
a steam turbine fluidly coupled to the initial steam flow path of the boiler to receive the steam from the boiler and to cause the steam turbine to rotate, the steam turbine being coupled to the core shaft to rotate the core shaft when the steam turbine rotates; and
a reheat boiler fluidly coupled to the steam turbine to receive the steam from the steam turbine and to reheat the steam, the reheat boiler including a reheat steam flow path to receive the steam and increase a temperature of the steam, the reheat steam flow path being a separate flow path from the initial steam flow path, wherein the combustor is fluidly coupled to the reheat steam flow path of the reheat boiler to receive the reheated steam.

2. The turbine engine of claim 1, wherein the combustor has a combustion pressure, the reheated steam being reheated by the reheat boiler to have a temperature greater than the boiling point of water at the combustion pressure.

3. The turbine engine of claim 1, wherein the reheat boiler is located upstream of the boiler relative to the flow of combustion gases.

4. The turbine engine of claim 1, wherein the reheat boiler is integrated into the boiler, the boiler having the initial steam flow path and the reheat steam flow path.

5. The turbine engine of claim 4, wherein the reheat steam flow path is located upstream of the initial steam flow path relative to the flow of combustion gases.

6. The turbine engine of claim 1, wherein the core shaft is a low-pressure shaft and the turbine is a low-pressure turbine.

7. The turbine engine of claim 6, wherein the combustion gases have a low-pressure turbine exit temperature, the reheated steam being reheated by the reheat boiler to have a temperature less than the low-pressure turbine exit temperature.

8. The turbine engine of claim 6, wherein the reheated steam is reheated by the reheat boiler to have a temperature from T₁ to T₂,
wherein the combustor has a combustion pressure, T₁ being the boiling point of water at the combustion pressure, and
wherein the combustion gases have a low-pressure turbine exit temperature, T₂ being 100° F. (38° C.) less than the low-pressure turbine exit temperature.

9. The turbine engine of claim 6, wherein the reheated steam is reheated by the reheat boiler to have a temperature from T₁ to T₂,
wherein the combustor has a combustion pressure, T₁ being the boiling point of water at the combustion pressure, and
wherein the combustion gases have a low-pressure turbine exit temperature, T₂ being 200° F. (93° C.) less than the low-pressure turbine exit temperature.

10. The turbine engine of claim 6, further comprising a low-pressure compressor connected to the low-pressure shaft to be driven by the low-pressure turbine and the steam turbine.

11. The turbine engine of claim 6, wherein the fan is coupled to the low-pressure shaft to be driven by the low-pressure shaft.

12. The turbine engine of claim 11, further comprising:
a bypass airflow passage, a first portion of air flowing into the fan flowing through the bypass airflow passage as bypass air and a second portion of the air flowing into the fan flowing through the core air flow path as core air; and
a condenser positioned downstream of the boiler and in the bypass airflow passage for bypass air to cool the combustion gases and to condense the water from the combustion gases.

13. The turbine engine of claim 12, further comprising a low-pressure compressor positioned in the core air flow path upstream of the combustor, the low-pressure compressor being driven by the low-pressure shaft to compress the core air flowing through the core air flow path and to generate the compressed air.

14. The turbine engine of claim 13, further comprising:
a high-pressure shaft;
a high-pressure turbine positioned downstream of the combustor to receive the combustion gases and to cause the high-pressure turbine to rotate, the high-pressure turbine coupled to the high-pressure shaft to rotate the high-pressure shaft when the high-pressure turbine rotates; and
a high-pressure compressor positioned in the core air flow path upstream of the combustor and downstream of the low-pressure compressor, the high-pressure compressor being driven by the high-pressure shaft to compress the core air flowing through the core air flow path and to generate the compressed air.

15. The turbine engine of claim 1, further comprising a condenser positioned downstream of the boiler to condense water from the combustion gases and to form an exhaust-water mixture.

16. The turbine engine of claim 15, further comprising a bypass airflow passage for bypass air, the condenser being positioned in the bypass airflow passage for bypass air to cool the combustion gases and to condense the water from the combustion gases, forming a cooled exhaust.

17. The turbine engine of claim 16, further comprising a water separator positioned downstream of the condenser, the water separator separating the water from the cooled exhaust.

18. The turbine engine of claim 17, wherein the water separator is a cyclonic separator.

19. The turbine engine of claim 17, wherein the boiler is fluidly coupled to the water separator.

20. The turbine engine of claim 19, further comprising a water pump in fluid communication with the water separator and with the boiler to direct the flow of water from the water separator into the boiler.
